(19) United States
(12) Patent Application Publication
(10) Pub. No.: US 2015/0286107 A1
(43) Pub. Date: Oct. 8, 2015

(54) ELECTROCHROMIC DISPLAY DEVICE AND MANUFACTURING METHOD THEREOF

(71) Applicant: BOE TECHNOLOGY GROUP CO., LTD., Beijing (CN)

(72) Inventors: Juan Chen, Beijing (CN); Xiaodong Zhou, Beijing (CN)

(21) Appl. No.: 14/360,684

(22) PCT Filed: Apr. 8, 2013
(86) PCT No.: PCT/CN13/73906

§ 371 Date: May 27, 2014

(30) Foreign Application Priority Data
Feb. 22, 2013 (CN) 201310057369.1

(51) Int. Cl. G02F 1/153; G02F 1/15; G02F 1/161; G02F 1/155

(52) U.S. Cl. CPC G02F 1/1533; G02F 1/155; G02F 1/1521; G02F 1/161

(57) ABSTRACT

An electrochromic display device and a manufacturing method thereof are disclosed. The electrochromic display device includes a first substrate (21), a second substrate (22) opposed to the first substrate (21), and an electrochromic fluid (23) distributed between the first substrate (21) and the second substrate (22), wherein a plurality of recesses (21′) are disposed on the first substrate (21), the electrochromic fluid (23) is separately disposed in the recesses (21′).

### TECHNICAL FIELD

Embodiments of the present invention relate to a field of display technology, and in particular, to an electrochromic display device and a manufacturing method thereof.

### BACKGROUND

Electrochromism refers to a phenomenon that optical properties of a material (e.g., reflectance, transmittance, absorptivity or the like) vary under an external electric field so that the appearance of the material exhibits a reversible and stable change of color. The fluid having an electrochromic property is known as electrochromic fluid, while a display device made from the electrochromic fluid is known as electrochromic display device. In comparison with other display devices, the electrochromic display device has many advantages, such as, no blind area, high contrast, low manufacturing cost, wide operating temperature range, low driving voltage, full-color, etc., and it is widely used in many fields, such as meter display, outdoor advertising or static display.

FIG. 1 is a cross-section view schematically illustrating a known electrochromic display device. The electrochromic display device comprises: a first substrate 10, a second substrate 20, and an electrochromic fluid 30 distributed between the first substrate 10 and the second substrate 20. The first substrate comprises a transparent substrate 101 and a first electrode layer 102; the second substrate comprises a transparent substrate 201 and a second electrode layer 202. The electrochromic fluid, which is located between the first electrode layer 102 and the second electrode layer 202, is uniformly distributed in various pixel areas of the electrochromic display device. There is no gap between the electrochromic fluid in any two adjacent pixel areas and the electrochromic fluid has fluidity, resulting in a phenomenon that adjacent pixel areas interfere with each other and adversely affecting the image definition and properties of the electrochromic display device.

### SUMMARY

Therefore, embodiments of the invention provide an electrochromic display device and a manufacturing method thereof.

According to a first aspect of the invention, it is provided an electrochromic display device comprising a first substrate, a second substrate opposed to the first substrate, and an electrochromic fluid distributed between the first substrate and the second substrate, wherein a plurality of recesses are disposed on the first substrate, the electrochromic fluid is separately disposed in each recess.

According to a second aspect of the invention, it is further provided a method of manufacturing an electrochromic display device comprising:

providing a first substrate and a second substrate;

forming a plurality of recesses on the first substrate;

forming a pixel electrode layer on a bottom of the recesses;

injecting an electrochromic fluid into each recess;

assembling the first substrate and the second substrate into a cell.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a cross-section view schematically illustrating a known electrochromic display device.

FIG. 2 is a cross-section structural view schematically illustrating an electrochromic display device provided by an embodiment of the present invention.

FIG. 3 is a cross-section structural view schematically illustrating a first substrate of an electrochromic display device provided by an embodiment of the present invention.

FIG. 4 is a structural view schematically illustrating a recess of an electrochromic display device provided by an embodiment of the present invention.

FIG. 5 is a structural view schematically illustrating a second substrate of an electrochromic display device provided by an embodiment of the present invention.

FIG. 6 is a view schematically illustrating a displaying effect of an electrochromic display device provided by an embodiment of the present invention.

### DETAILED DESCRIPTION

In order to make objects, technical details and advantages of the embodiments of the invention apparent, the technical solution of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The use of “including,” “comprising” or “having” and variations thereof herein is meant to encompass the items listed thereafter and equivalents thereof as well as additional items. The terms “connected” and “coupled” are not restricted to physical or mechanical connections or couplings, and can include electrical connections or couplings, whether direct or indirect. The terms such as “front”, “back”, “bottom”, and/or “top” is only used to represent the relative position, which may be changed according to the absolute position change of the object described.

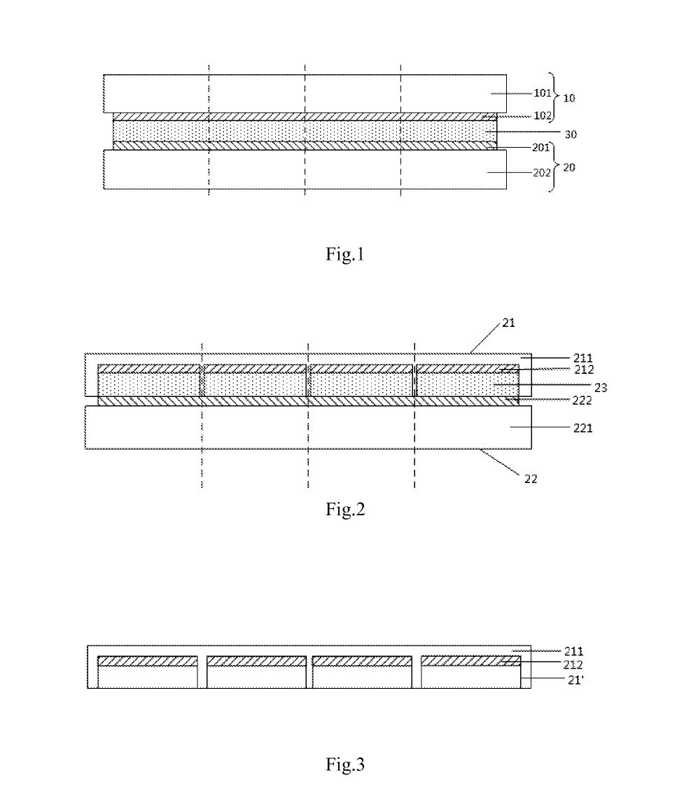

As illustrated in FIG. 2 and FIG. 3, an electrochromic display device comprises: a first substrate 21, a second substrate 22 opposed to the first substrate 21, and an electrochromic fluid 23 distributed between the first substrate 21 and the second substrate 22, wherein a plurality of recesses 21′ is disposed on the first substrate 21, the electrochromic fluid 23 is separately disposed in a plurality of recesses 21′. The interference between adjacent pixel areas can be eliminated by isolating the electrochromic fluid in the recesses. For example, the electrochromic fluid 23 comprises an electrochromic material and an electrolyte, in an example, the electrochromic material comprises viologen material.

Specifically, each of the first substrate 21 and the second substrate 22 comprises a base substrate and a pixel electrode layer. The second substrate 22 comprises a second base substrate 221. A thin film transistor (not shown) and a second pixel electrode layer 222 are disposed on the second base substrate 211. The first substrate comprises a first base substrate 211, on which a plurality of recesses 21′ is disposed. In an example, the depth of the recesses 21′ is in a range from 20 μm to 80 μm. A first pixel electrode layer 212 is disposed on the bottom of each recess 21′. In this embodiment, the recesses 21′ can be formed by mechanical thinning or chemical thinning process. The thickness of the bottom floor of the recesses 21′ is in a range from 2 μm to 10 μm. The skilled in the art may make various modifications to the dimension of the recesses as desired. The thickness of the wall between any two adjacent recesses 21′ ranges from 2 μm to 10 μm. When forming the recesses 21′, the thickness of the bottom floor and the thickness of the wall between any two adjacent recesses 21′ may be adjusted based on the practical demands. In this embodiment, base substrates 211, 221 are made of glass, polymer or composite materials, as an example, they are made of transparent glass.

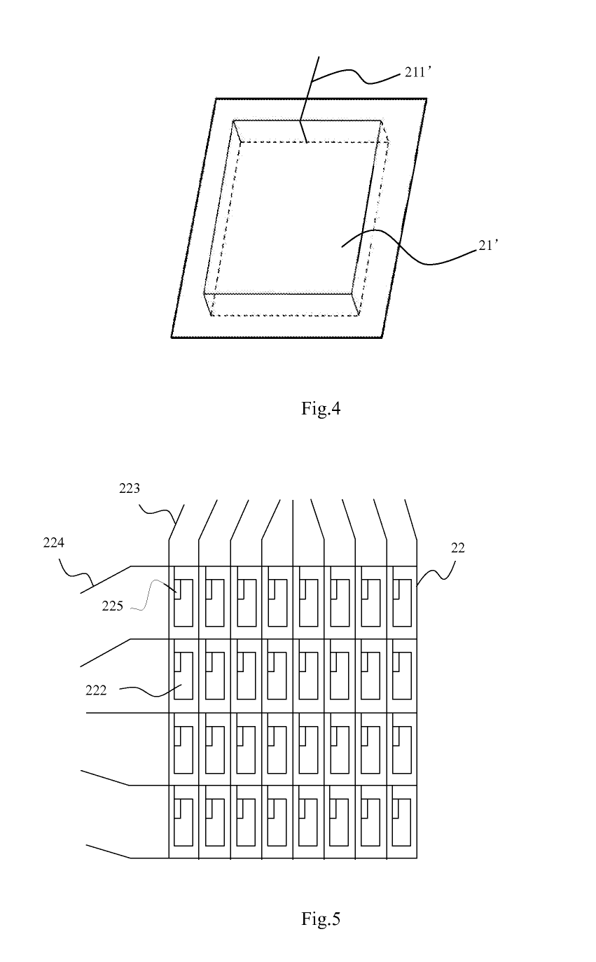

As illustrated in FIG. 4, a metal wire 211′ is disposed in the recess 21′, for example on a sidewall of the recess 21′. For electrifying the first pixel electrode 212, the metal wire 211′ is connected to the first pixel electrode 212 on the bottom of the recess 21′.

As illustrated in FIG. 5, when the second substrate 22 is an array substrate, the array substrate comprises a second base substrate, on which a plurality of data lines 223 and gate lines 224 are formed. The array substrate further comprises a plurality of pixel units defined by the data lines 223 and the gate lines 224, wherein each pixel unit comprises a thin film transistor switch 225 and a second pixel electrode layer 222, both of which are formed on the second base substrate. The second substrate 22 may be prepared by a known process for manufacturing an array substrate.

An embodiment of the present invention also provides a method of manufacturing an electrochromic display device, and the method comprises the steps of:

providing a first substrate 21 and a second substrate 22;

forming a plurality of recesses 21′ on the first substrate 21;

forming a first pixel electrode layer 212 on the bottom of each recess 21′;

injecting the electrochromic fluid 23 into each recess 21′; and

assembling the first substrate 21 and the second substrate 22 into a cell (as illustrated in FIG. 2).

In an embodiment, the recesses 21′ are formed on the first substrate 21 by mechanical thinning or chemical thinning process. In an embodiment, nitrogen gas is provided to pass through the electrochromic fluid 23 after injecting the electrochromic fluid 23 into each recess 21′, so as to remove the oxygen.

In an embodiment, the step of assembling the first substrate 21 and the second substrate 22 into a cell comprises: coating a sealant onto the non-recessed region of the first substrate 21 and attaching the first substrate 21 to the second substrate 22 by the sealant.

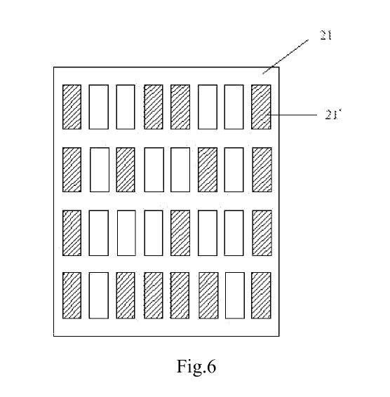

Referring to FIG. 6, the electrochromic display device according to the embodiment of the present invention is provided with data lines 223 and gate lines 224 so as to achieve active displaying. Various images, such as characters or numbers, will be displayed by inputting voltage signals to different date lines or gate lines. As illustrated in FIG. 6, the pixel areas with shadow lines represent the areas to which voltage signals are input; the pixel areas without shadow lines represent the areas to which voltage signals are not input. Because the electrochromic fluid is separated by the recesses 21′, the interference between adjacent pixel areas can be eliminated. In this embodiment, the recesses 21′ is in the form of array with equal intervals.

The electrochromic display device provided in all the embodiments of the present invention has a substrate provided with a plurality of recesses, and the electrochromic fluid is placed in the recesses, thus the electrochromic fluid can be separated by the recesses in respective pixel areas so as to eliminate the interference between adjacent pixels and improve the performance of the electrochromic display device.

1. An electrochromic display device comprising: a first substrate, a second substrate opposed to the first substrate, and an electrochromic fluid distributed between the first substrate and the second substrate, wherein a plurality of recesses is disposed on the first substrate, the electrochromic fluid is separately disposed in the plurality of the recesses.

2. The electrochromic display device according to claim 1, wherein the first substrate comprises a first base substrate, the plurality of recesses is disposed on the first base substrate.

3. The electrochromic display device according to claim 1, wherein a depth of each recess is in a range from 20 μm to 80 μm.

4. The electrochromic display device according to claim 1, wherein a thickness of a wall between any two adjacent recesses ranges from 2 μm to 10 μm.

5. The electrochromic display device according to claim 1, wherein the first substrate further comprises a first pixel electrode layer, which is disposed on a bottom of each recess.

6. The electrochromic display device according to claim 5, wherein a wire connected to the first pixel electrode layer is disposed in each recess and configured to electrify the first pixel electrode layer.

7. The electrochromic display device according to claim 5, wherein the second substrate comprises a second base substrate and a second pixel electrode layer disposed on the second base substrate, the first pixel electrode layer is opposed to the second pixel electrode layer.

8. The electrochromic display device according to claim 1, wherein the electrochromic fluid comprises an electrochromic material, the electrochromic material comprises viologens.

9. The electrochromic display device according to claim 2, the base substrate is a glass substrate, a polymer substrate or a substrate made of the composite materials.

10. A method of manufacturing an electrochromic display device, comprising:
providing a first substrate and a second substrate;
forming a plurality of recesses on the first substrate;
forming a pixel electrode layer on a bottom of each recess;
injecting an electrochromic fluid into each recess;
assembling the first substrate and the second substrate into a cell.

11. The method according to claim 10, wherein the plurality of recesses on the first substrate is formed by a mechanical thinning process or chemical thinning process.

12. The method according to claim 10, wherein nitrogen gas is provided to pass through the electrochromic fluid after injecting the electrochromic fluid into each recess.

13. The method according to claim 10, wherein assembling the first substrate and the second substrate into a cell comprises:
coating a sealant onto a non-recessed region of the first substrate; and
attaching the first substrate to the second substrate face to face by the sealant.

14. The electrochromic display device according to claim 2, wherein the first substrate further comprises a first pixel electrode layer, which is disposed on a bottom of each recess.

15. The electrochromic display device according to claim 3, wherein the first substrate further comprises a first pixel electrode layer, which is disposed on a bottom of each recess.

16. The electrochromic display device according to claim 4, wherein the first substrate further comprises a first pixel electrode layer, which is disposed on a bottom of each recess.

17. The electrochromic display device according to claim 6, wherein the second substrate comprises a second base substrate and a second pixel electrode layer disposed on the second base substrate, the first pixel electrode layer is opposed to the second pixel electrode layer.

18. The electrochromic display device according to claim 7, the base substrate is a glass substrate, a polymer substrate or a substrate made of the composite materials.

19. The method according to claim 11, wherein nitrogen gas is provided to pass through the electrochromic fluid after injecting the electrochromic fluid into each recess.

20. The method according to claim 11, wherein assembling the first substrate and the second substrate into a cell comprises:
coating a sealant onto a non-recessed region of the first substrate; and
attaching the first substrate to the second substrate face to face by the sealant.
